(19) United States
(12) Patent Application Publication
(10) Pub. No.: US 2020/0118133 A1
(43) Pub. Date: Apr. 16, 2020

(54) SYSTEMS AND METHODS FOR CONTINUATION OF RECURRING CHARGES, WHILE MAINTAINING FRAUD PREVENTION

(71) Applicant: Capital One Services, LLC, McLean, VA (US)

(72) Inventors: John SCHMIDT, Falls Church, VA (US); Joshua WILBUR, Potomac, MD (US); Sruthi KATTAMURI, I, McLean, VA (US); Krystle VOSS, Alexandria, VA (US); Colleen KERR, Chicago, IL (US); Riken SHAH, Ashburn, VA (US); Jeffrey SAMITT, Glen Allen, VA (US)

(73) Assignee: Capital One Services, LLC, McLean, VA (US)

(21) Appl. No.: 16/351,747

(22) Filed: Mar. 13, 2019

Related U.S. Application Data
(63) Continuation of application No. 16/159,097, filed on Oct. 12, 2018.

(51) Int. Cl. G06Q 20/40; G06Q 20/10; G06Q 20/28

(52) U.S. Cl. CPC G06Q 20/4016; G06Q 20/28; G06Q 20/102

(57) ABSTRACT

The disclosed embodiments generally relate to systems and methods for implementing user-authorized recurring transactions with trusted merchants for fraud prevention. In one embodiment, a computer-implemented method is disclosed, in which a payment processing network receives a payment request via a computer network, and determines a payment account associated with the received payment request. The payment processing network determines that the payment account is unusable because fraudulent activity has been identified with the payment account, and that the payment request is a recurring payment request. The payment processing network transmits a fraud decline override request to a financial service provider system, and based on a fraud decline override response received from the financial service provider system, processes the payment request.

### TECHNICAL FIELD

The disclosed embodiments generally relate to systems and methods for implementing user-authorized recurring transactions with trusted merchants, while implementing fraud prevention measures.

### BACKGROUND

In current payment systems, once a customer's payment account (e.g., a credit or debit card) and/or payment method associated with the payment account becomes associated with fraudulent behavior, the payment account and/or method generally are deactivated immediately to prevent further fraudulent use of the account. Specifically, financial account providers typically deactivate payment account and/or method immediately, and arrange for a new payment account and/or method to be set up and provided to the customer. For example, once a credit card number or account is associated with fraudulent behavior, the credit card and account number will no longer be usable in any manner by any party, including the customer, even when the customer remains in physical possession of the credit card itself. In some situations, it may take several days and up to more than one week for the customer to receive a replacement card and account number. During this time, a customer may be significantly inconvenienced by the inability to use the account in any way.

Thus, there is a need for systems and methods capable of enabling legitimate continued use of a compromised payment account and/or method to conduct transactions while reducing the potential of fraudulent use.

### SUMMARY

In the following description, certain aspects and embodiments of the present disclosure will become evident. It should be understood that the disclosure, in its broadest sense, could be practiced without having one or more features of these aspects and embodiments. It should also be understood that these aspects and embodiments are merely exemplary.

The disclosed embodiments include a system for processing a recurring payment transaction using an otherwise disabled payment account. The system includes one or more memory devices storing instructions, and one or more processors configured to execute the instructions to receive a payment request via a computer network, and determine a payment account associated with the received payment request. The one or more processors are also configured to determine that the payment account is unusable because fraudulent activity has been identified with the payment account, and that the payment request is a recurring payment request. The one or more processors are also configured to transmit a fraud decline override request to a financial service provider system. The one or more processors are also configured to receive a fraud decline override response to the fraud decline override request, and process the payment request based on the received fraud decline override response.

The disclosed embodiments include a computer-implemented method for processing a recurring payment transaction using an otherwise disabled payment account. The method includes receiving, by one or more processors, a payment request via a computer network, and determining, by the one or more processors, a payment account associated with the received payment request. The method further includes determining, by the one or more processors, that the payment account is unusable because fraudulent activity has been identified with the payment account, and that the payment request is a recurring payment request. The method includes transmitting, by the one or more processors, a fraud decline override request to a financial service provider system. The method also includes receiving, by the one or more processors, a fraud decline override response to the fraud decline override request, and processing the payment request based on the received fraud decline override response.

In accordance with additional embodiments of the present disclosure, a computer-readable medium is disclosed that stores instructions that, when executed by a processor(s), cause the processor(s) to perform operations consistent with one or more disclosed methods.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate several embodiments and, together with the description, serve to explain the disclosed principles. In the drawings:

FIG. 1 is a block diagram of an exemplary system, consistent with the disclosed embodiments;

FIG. 2 is a block diagram of an exemplary computing system, consistent with the disclosed embodiments;

FIGS. 3-5 are examples of a mobile application graphical user interface for enabling use of an otherwise disabled payment account in recurring payment transactions, consistent with the disclosed embodiments;

FIGS. 6-7 are examples of a web browser graphical user interface for enabling use of an otherwise disabled payment account in recurring payment transactions, consistent with the disclosed embodiments;

FIG. 8 is a flowchart of an exemplary process for enabling use of an otherwise disabled payment account in recurring payment transactions, consistent with the disclosed embodiments;

FIGS. 9A-C are flowcharts of an exemplary process for processing a recurring payment transaction using an otherwise disabled payment account, consistent with the disclosed embodiments.

### DETAILED DESCRIPTION

Reference will now be made in detail to exemplary embodiments, examples of which are illustrated in the accompanying drawings and disclosed herein. Wherever convenient, the same reference numbers will be used throughout the drawings to refer to the same or like parts.

The present disclosure describes an advantageous, rule-based transaction authorization system and method for enabling continued use, on a restricted basis, of a payment account and/or method for which a financial service provider has identified fraudulent activity or has otherwise declared unusable. In some embodiments, continued use of the payment account and/or method may be limited to certain user-authorized recurring transactions with trusted merchants. A user of the payment account and/or method, through a mobile app or web browser interface, may identify trusted merchants whose recurring payment requests are authorized even though the user's payment account and/or method has been otherwise deactivated to prevent fraudulent use of the account. The user's authorization preferences may be stored by a financial service provider or other payment processing entity. When a user-trusted merchant issues a request for a recurring payment using the deactivated payment account and/or method, the financial service provider or payment processing entity may look up the user's stored preferences on recurring charges, and determine that the request is user-authorized despite the payment account and/or method being otherwise deactivated to prevent fraudulent use of the account. The payment processing entity may then override a decline of the transaction due to security fraud, and instead process the user-authorized recurring payment transaction.

A common trigger for preventing use of a payment account and/or method includes the detection of fraudulent (or potentially fraudulent) behavior using the payment account and/or method. For many financial service providers, a payment account and/or method may be declared inactive upon detection of fraudulent behavior, thus preventing any use of the payment account and/or method by any person, including the owner of the account. In many cases, a customer or owner of the account may have provided merchants with payment information (e.g., for a payment card, credit card, debit card, etc.) to periodically (e.g., monthly) initiate recurring payment transactions (e.g., payment of utility bills, rent, credit card balances, etc.). Such recurring payment transactions would be processed using the payment account and/or method but for the financial service provider declaring the account unusable. The disclosed embodiments enable customers to authorize continued use of the payment account and/or method for such recurring transactions with trusted merchants.

In some embodiments, a customer may indicate that a payment account and/or method may be authorized for use in a transaction, even if the payment account and/or method has otherwise been disabled or declared unusable. The indication may be made using a mobile device application, web browser, or other device. A user of the payment account and/or method, through the mobile application or web browser interface, may identify trusted merchants whose recurring payment requests are authorized even though the user's payment account and/or method has been otherwise deactivated to prevent fraudulent use of the account. For example, the user may identify trusted merchants, whose recurrent payment transactions may be authorized, and blocked merchants, whose recurrent payment transactions are not authorized. For trusted merchants, the user may indicate, on a transaction-by-transaction basis, whether the recurring payment transaction is temporarily paused or currently active. The user may further indicate on a transaction-by-transaction basis, in the event the user's payment account and/or method has been deactivated to prevent fraudulent use of the account, whether the recurring payment transaction should be continued or discontinued while the user waits to receive a replacement card and account number. A trusted merchant may then continue normal use of the payment account and/or method for initiating a user authorized recurring payment transaction, even if the user's payment account and/or method has been deactivated to prevent fraudulent use of the account.

During a pre-authorization process for a transaction initiated with the payment account and/or method, a financial service provider or associated payment processor may determine whether the payment transaction requested by the merchant is a recurring payment transaction. If it is a recurring payment transaction, the financial service provider or associated payment processor may determine whether the user has indicated that the merchant is a trusted merchant. If the user has indicated that the merchant is a trusted merchant, the financial service provider or associated payment processor may further determine whether the requested recurrent payment transaction is user authorized and currently active. Upon determining that the requested recurrent payment transaction is user authorized and currently active, the financial service provider or associated payment processor may authorize the transaction.

Thus, the disclosed systems and methods address problems known to traditional systems in the transaction technology fields. For example, in many situations, users that remain in possession of a payment card or other payment account and/or method may be significantly inconvenienced by the inability to continue use of the payment account and/or method once a financial service provider has decided to “deactivate” the payment account and/or method or otherwise declare the payment account and/or method unusable. Some users may not possess another payment card, and in an emergency situation may be unable to initiate a necessary transaction. Despite a history of, or potential for, fraudulent activity using a payment account and/or method, the disclosed systems and methods may enable continued, restricted, and/or limited use of the payment account and/or method for specific recurring payment transactions that present a lower probability of fraudulent behavior, and that have additionally been authorized by the user who has also indicated that the requesting merchant is trusted. These authentication measures are dynamic and not easily spoofed or otherwise capable of re-creation by a fraudster. Additionally, in some embodiments, a payment account and/or method may be “activated” for a specific recurring transaction or set of recurring transactions for a limited duration of time in which a trusted merchant may initiate the recurring transaction using the payment account and/or method. It is unlikely that a fraudster may coincidentally also attempt to use the payment account for a transaction during the limited window of time.

The following disclosure provides exemplary systems and methods for enabling continued use, on a restricted basis, of a payment account and/or method for which a financial service provider has identified fraudulent activity or has otherwise declared unusable, thus realizing the above advantages and benefits over conventional systems.

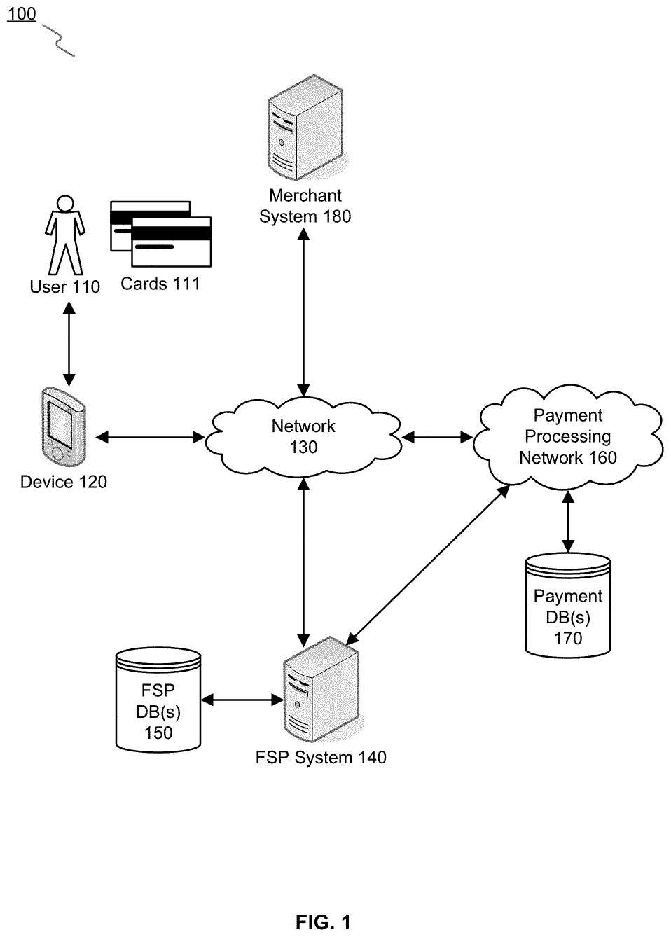

FIG. 1 is a block diagram of an exemplary system, consistent with the disclosed embodiments. As shown in FIG. 1, system 100 may include a user device 120 and one or more payment cards 111 associated with a user 110. System 100 may also include a merchant system 180 with which user 110 may enter into a transaction using payment cards 111 or user device 120. Merchant system 180 may communicate with a financial service provider (FSP) system 140 via a payment processing network 160 to authorize the transaction. System 100 may also include an FSP database 150 and a payment database 170 accessible to FSP system 140 and/or payment processing network 160 to authorize or otherwise process the transaction, among other things. System 100 may also include a network 130 to facilitate communication among the components of system 100 and, in some embodiments, to enable user device 120 to conduct an e-commerce transaction with merchant system 180. Network 130 may also facilitate user device 120 to communicate with FSP system 140 to request and register one or more transaction rules to be associated with a user's 110 account with the financial service provider, consistent with the disclosed embodiments.

The components and arrangement of the components included in system 100 may vary. Thus, system 100 may further include other components that perform or assist in the performance of one or more processes consistent with the disclosed embodiments. The components and arrangements shown in FIG. 1 are not intended to limit the disclosed embodiments, as the components used to implement the disclosed processes and features may vary.

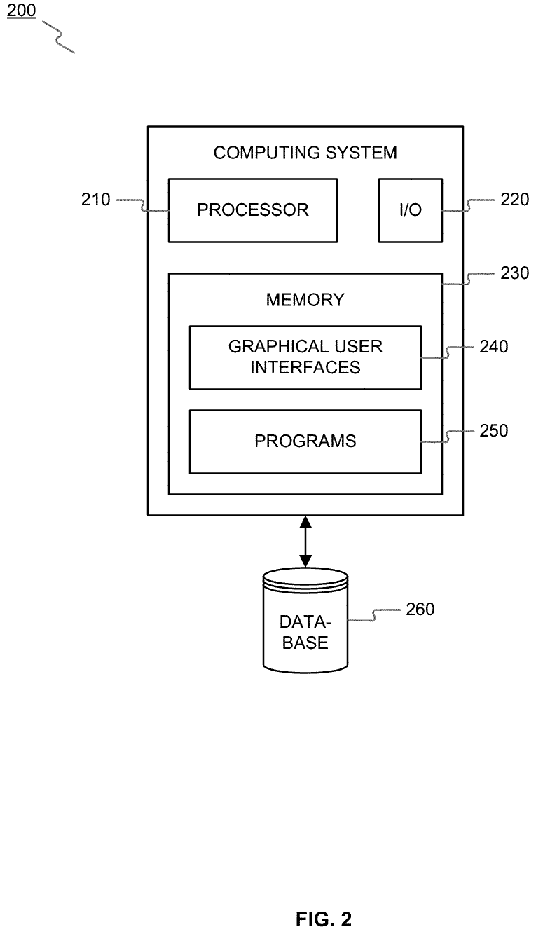

System 100 may include one or more user devices 120 associated with one or more users 110. A user 110 may operate a user device 120, which may be a desktop computer, laptop, tablet, smartphone, multifunctional watch, pair of multifunctional glasses, tracking device, or any suitable device with computing capability. User device 120 may have a financial application installed thereon, which may enable user device 120 to communicate with FSP system 140 via network 130 and perform aspects of the disclosed methods. For example, user device 120 may connect to FSP system 140 and/or merchant system 180 through use of a mobile application or browser software. User device 120 may allow a user to access information stored in FSP system 140, such as, for example, financial information related to recent purchase transactions, financial statements, account information, rewards program information and the like. User device 120 may also be configured to enter a purchase or payment transaction as a mobile payment device. An exemplary computer system consistent with user device 120 is discussed in additional detail with respect to FIG. 2.

User 110 may operate user device 120 to perform one or more operations for managing a customer or client account associated with FSP system 140, such as entering a payment transaction. In some aspects, user 110 may be a customer or client of a financial service provider associated with FSP system 140. For instance, a financial service provider may maintain a financial service account (e.g., credit card account, checking account, etc.) that the user 110 may use in a transaction, such as, for example, a purchase of goods and/or services online or at brick and mortar locations associated with a merchant relating to merchant system 180. Consistent with disclosed embodiments, user 110 may operate user device 120 to initiate a purchase transaction with a merchant or merchant system 180. Payment transactions initiated with user device 120 may include an e-commerce transaction or a mobile payment transaction. A purchase transaction may also be initiated with a merchant or merchant system 180 using any known method, such as presentation of a payment card 111 (e.g., a bank card or credit card), or the presentation of information associated with a bank card or credit card. Further, user 110 may operate user device 120 to view a financial service account or financial statement provided by a financial service provider or FSP system 140 and perform certain requests to enable continued use of a payment account and/or method that may otherwise have been disabled or declared unusable.

Payment card 111 may be implemented as a physical card or other payment device, typically issued by a financial service provider and associated with a customer or client account. Payment card 111 may also be configured as a dongle, a fob, an e-wallet, or any electronic device enabling user 110 to enter into a transaction. In some embodiments, payment card 111 may be presented at a merchant or merchant system 180 to initiate a transaction. In the disclosed embodiments, payment card 111 and/or user device 120 may correspond to a payment account and/or method when used to enter into a transaction.

In accordance with disclosed embodiments, FSP system 140 may be a system associated with a financial service provider (not shown), such as a bank, a credit card company, a lender, brokerage firm, or any other type of financial service entity that generates, provides, manages, and maintains financial service accounts for users 110. FSP system 140 may include one or more computing systems that are configured to execute software instructions stored on one or more memory devices to perform operations consistent with the disclosed embodiments. For example, FSP system 140 may include one or more memory device(s) storing data and software instructions and one or more processor(s) configured to use the data and execute the software instructions to perform server-based functions and operations known to those skilled in the art. FSP system 140 may include one or more computing components specifically programmed and combined or arranged to perform the disclosed methods.

In certain embodiments, FSP system 140 may be configured as a particular apparatus, system, and the like, based on the storage, execution, and/or implementation of the software instructions that perform operations consistent with the disclosed embodiments. FSP system 140 may be standalone, or it may be part of a subsystem, which in turn may be part of a larger system. For example, FSP system 140 may represent distributed servers that are remotely located and communicate over a public network (e.g., network 130) or a dedicated network, such as a LAN, for a financial service provider. An exemplary computing system consistent with FSP system 140 is discussed in additional detail with respect to FIG. 2, below.

FSP system 140 may include or may access one or more storage devices configured to store data and/or software instructions used by one or more processors of FSP system 140 to perform operations consistent with the disclosed embodiments. For example, FSP system 140 may include memory configured to store one or more software programs that perform several operations when executed by a processor, including operations specific to the disclosed methods. The disclosed embodiments are not limited to separate programs or computers configured to perform dedicated tasks. For example, FSP system 140 may include memory that stores a single program or multiple programs. Additionally, FSP system 140 may execute one or more programs located remotely from FSP system 140. For example, FSP system 140 may access one or more remote programs stored in memory included with a remote component (such as FSP database 150) that, when executed, perform operations consistent with the disclosed embodiments.

In certain aspects, FSP system 140 and/or database 150 may include server software that generates, maintains, and provides services associated with processing financial transactions. In some embodiments, FSP system 140 may connect with separate server(s) or other computing devices associated with database 150 that generate, maintain, and provide services associated with financial data for a financial service provider associated with FSP system 140. For example, database 150 may include a number of storage and processing components and associated software for storing account information of customers or clients of a financial service provider for use in authorizing and processing a transaction. Database 150 may be associated with FSP system 140 and made accessible to payment processing network 160 for performing various transaction authorization and processing functionality. In some embodiments, database 150 may be provided as part of payment processing network 160, and/or may be combined with payment database 170.

System 100 may also include one or more merchant systems 180. Merchant system 180 may be a computing system that is associated with a merchant or other business entity that provides goods and/or services, such as a restaurant, retailer, grocery store, service provider (e.g., utilities, etc.), or any other type of entity that may engage in any financial transaction (e.g., charity, tax collector, etc.) or other commercial transaction with a consumer, including health care providers, education providers, etc. While system 100 is shown with a single merchant system 180 for ease of discussion, the disclosed embodiments may also be implemented in a system 100 including two or more merchant systems 180 associated with any number of underlying entities (commercial or otherwise). Further, merchant system 180 is not limited to conducting business in any particular industry or field.

Merchant system 180 may be associated with a merchant brick-and-mortar location(s) that a user 110 may physically visit and purchase goods and services. Such physical locations may include computing devices that perform financial service transactions with consumers (e.g., Point of Sale (POS) terminal(s), kiosks, etc.). Merchant system 180 may also include one or more location sensing devices configured to sense the presence or location of a user based on signals received from user device 120 or payment cards 111. Merchant system 180 may also include back- and/or front-end computing components that store data and execute software instructions to perform operations consistent with the disclosed embodiments, such as computers that are operated by employees of the merchant (e.g., back office systems, etc.). Merchant system 180 may also be associated with a merchant that provides goods and/or services via known online or e-commerce types of solutions. For example, such a merchant may sell goods or otherwise accept payment via a website using known online or e-commerce solutions to market, sell, and process online transactions conducted via network 130, for example.

In one embodiment, merchant system 180 may include one or more servers or other type of computer devices. The merchant system server(s) may be one or more computing devices configured to execute software instructions stored in memory to perform operations consistent with the disclosed embodiments. For example, merchant system 180 may include one or more memory device(s) storing data and software instructions, and one or more processor(s) configured to use the data and execute the software instructions to perform server-based operations known to those skilled in the art.

Merchant system 180 may further include servers that are configured to execute stored software instructions to perform operations associated with a merchant, including operations associated with pre-authorization and processing of purchase transactions, generating transaction data (e.g., merchant name and location identifiers), and generating product data (e.g., SKU data) relating to purchase transactions, etc. Merchant system 180 may include one or more servers that may include a general-purpose computer, a mainframe computer, or any combination of these components. In certain embodiments, merchant system 180 (or a system including merchant system 180) may be configured as a particular apparatus, system, and the like based on the storage, execution, and/or implementation of the software instructions that perform operations consistent with the disclosed embodiments. A merchant server may be standalone, or it may be part of a subsystem, which may be part of a larger system. For example, a merchant server may represent distributed servers that are remotely located and communicate over a public network (e.g., network 130) or a dedicated network, such as a LAN. An exemplary computing system consistent with merchant system 180 is discussed in additional detail with respect to FIG. 2.

In certain aspects, merchant system 180 may include one or more web servers that execute software that generates, maintains, and provides a web site(s) for a respective merchant that is accessible over network 130. In other aspects, a merchant system 180 may connect separately to web server(s) or similar computing devices that generate, maintain, and provide a web site(s) for a merchant.

In certain embodiments, a merchant may operate computing components associated with merchant system 180 to perform operations consistent with the disclosed embodiments. For example, merchant system 180 may be configured to execute software instructions to provide transaction data and/or product data and other data relating to purchase transactions to FSP system 140 over network 130 or payment processing network 160. Additionally, merchant system 180 may be configured to execute software instructions to perform pre-authorization and other transaction processing operations regarding a transaction entered into using a financial service account associated with FSP system 140. These operations may be performed using payment processing network 160 that may be in communication with FSP system 140 and FSP database 150.

Payment processing network 160 may include any number of computing components, systems, and subsystems in communication with merchant system 180, FSP system 140, and FSP database 150 for processing a payment transaction. For conciseness, payment processing network 160 may include any configuration or combination of known payment processing networks and systems implemented for authorizing, clearing, and settling a transaction. Payment processing network 160 may generally include the underlying systems for receiving a transaction authorization request from a merchant system 180, performing verification and fraud analysis on the payment account and/or method, communicating with a FSP system 140 associated with the payment account and/or method, providing an authorization decision to merchant system 180, clearing an authorized transaction, and settling the transaction through the payment of funds or otherwise. In some embodiments, payment processing network 160 may include a payment database 170 as well as a number of systems not shown, such as a financial service provider system associated with merchant system 180, a third party payment processor system, a card network and processing system (e.g., such as Visa, MasterCard, etc.) and any other systems related to processing payment transactions. In some embodiments, aspects of payment processing network 160 may include aspects of network 130 for the communication of various transaction data or other communications between various systems of payment processing network 160.

Network 130 may comprise any type of computer networking arrangement used to exchange data. For example, network 130 may be the Internet, a private data network, a virtual private network using a public network, a Wi-Fi network, a LAN or WAN network, and/or other suitable connections that may enable information exchange among various components of system 100. Network 130 may also include a public switched telephone network (“PSTN”) and/or a wireless cellular network. Network 130 may be a secured network or unsecured network. In some embodiments, one or more components of system 100 may communicate directly through a dedicated communication link(s), such as links between FSP system 140 and merchant system 180.

Other components known to one of ordinary skill in the art may be included in system 100 to process, transmit, provide, and receive information consistent with the disclosed embodiments. In addition, although not shown in FIG. 1, components of system 100 may communicate with each other through direct communications, rather than through network 130. Direct communications may use any suitable technologies, including close range communication protocols, such as those employed under the name BLUETOOTH™ or BLUETOOTH LE™, and Wi-Fi, or any known near field communications (NFC) techniques, or other suitable communication methods that provide a medium for transmitting data between separate devices. In some embodiments, user device 120 and/or payment cards 111 may communicate with one or more merchant systems 180 using direct communication technologies to transmit location information or other information used to determine the location of user device 120 and/or payment cards 111.

System 100 includes a number of components generally described as computing devices. Each of the computing devices may include any number of computing components particularly configured as a special-purpose computing device to perform the functionality disclosed herein. FIG. 2 shows a diagram of an exemplary computing system 200 illustrating a computing system configuration that may be associated with FSP system 140, merchant system 180, one or more payment processing systems provided as part of payment processing network 160, and/or user device 120, consistent with the disclosed embodiments.

FIG. 2 is a block diagram of an exemplary computing system, consistent with the disclosed embodiments. As shown in FIG. 2, computing system 200 may be associated with device 120, merchant system 180, devices included in payment processing network 160, FSP server 140, or any of the devices included in network 730, consistent with disclosed embodiments. In one embodiment, computing system 200 may have one or more processors 210, one or more memories 230, and one or more input/output (I/O) devices 220. In some embodiments, computing system 200 may take the form of a server, general-purpose computer, a mainframe computer, laptop, smartphone, mobile device, or any combination of these components. In certain embodiments, computing system 200 (or a system including computing system 200) may be configured as a particular apparatus, system, and the like based on the storage, execution, and/or implementation of the software instructions that perform one or more operations consistent with the disclosed embodiments. Computing system 200 may be standalone, or it may be part of a subsystem, which may be part of a larger system.

Processor 210 may include one or more known processing devices, such as a microprocessor from the Pentium™ or Xeon™ family manufactured by Intel™, the Turion™ family manufactured by AMD™, or any of various processors manufactured by Sun Microsystems. Processor 210 may constitute a single-core or multiple-core processor that executes parallel processes simultaneously. For example, processor 210 may be a single-core processor configured with virtual processing technologies. In certain embodiments, processor 210 may use logical processors to simultaneously execute and control multiple processes. Processor 210 may implement virtual machine technologies, or other known technologies to provide the ability to execute, control, run, manipulate, store, etc. multiple software processes, applications, programs, etc. In another embodiment, processor 210 may include a multiple-core processor arrangement (e.g., dual, quad core, etc.) configured to provide parallel processing functionalities to allow computing system 200 to execute multiple processes simultaneously. One of ordinary skill in the art would understand that other types of processor arrangements could be implemented that provide for the capabilities disclosed herein. The disclosed embodiments are not limited to any type of processor(s) configured in computing system 200.

Memory 230 may include one or more storage devices configured to store instructions used by processor 210 to perform functions related to the disclosed embodiments. For example, memory 230 may be configured with software instructions, such as program(s) 250 that may perform operations when executed by processor 210. The disclosed embodiments are not limited to separate programs or computers configured to perform dedicated tasks. For example, memory 230 may include a program 250 that performs the functions of computing system 200, or program 250 could comprise multiple programs. Additionally, processor 210 may execute one or more programs located remotely from computing system 200. For example, user devices 120, devices included in payment processing network 160 or network 130, FSP database 150, payment database 170, merchant servers 180, and FSP servers 140, may, via computing system 200 (or variants thereof), access one or more remote programs that, when executed, perform functions related to certain disclosed embodiments. Processor 210 may further execute one or more programs located in database 260. In some embodiments, programs 250 may be stored in an external storage device, such as a cloud server located outside of computing system 200, and processor 210 may execute programs 250 remotely.

Programs executed by processor 210 may cause processor 210 to execute operations related to implementing merchant business intelligence tools. Programs executed by processor 210 may further cause processor 210 to execute operations related to statistical demographic analysis of customer information. Programs executed by processor 210 may also cause processor 210 to execute operations related to financial services provided to users including, but not limited to, processing credit and debit card transactions, checking transactions, fund deposits and withdrawals, transferring money between financial accounts, lending loans, processing payments for credit card and loan accounts, processing ATM cash withdrawals, or the like. Programs executed by processor 210 may further cause processor 210 to execute operations related to aggregating consumer financial transaction data, user profile data, and merchant information.

Memory 230 may also store data reflecting any type of information in any format that the system may use to perform operations consistent with the disclosed embodiments. Memory 230 may store instructions to enable processor 210 to execute applications, such as server applications, a customer data aggregation application, a customer demographic statistical analysis application, network communication processes, and any other type of application or software. Alternatively, the instructions, application programs, etc. may be stored in an external storage (not shown) in communication with computing system 200 via communication network 130 or any other suitable network. Memory 230 may be a volatile or non-volatile, magnetic, semiconductor, tape, optical, removable, non-removable, or other type of storage device or tangible (e.g., non-transitory) computer-readable medium.

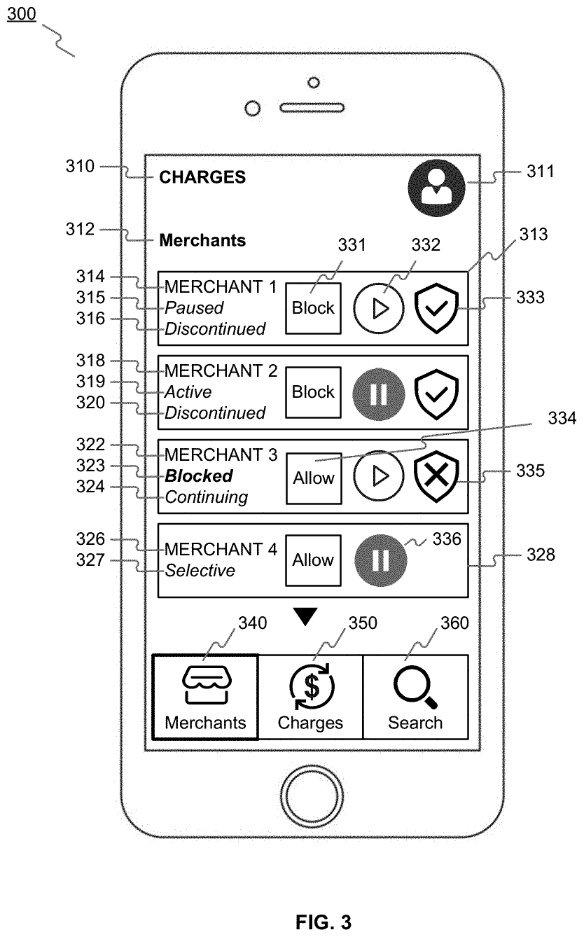

Memory 230 may include graphical user interface(s) (“GUI”) 240. GUI 240 may allow a user to access, modify, etc. user profile information, user demographic information, user authorization preferences, and/or the like. In certain aspects, as explained further below with reference to FIGS. 3-7, GUI 240 may facilitate an operator to view user authorization preferences, or the like. Additionally or alternatively, GUI 240 may be stored in database 260 or in an external storage (not shown) in communication with computing system 200 via networks 130 or any other suitable network.

I/O device 220 may be one or more devices configured to allow data to be received and/or transmitted by computing system 200. I/O device 220 may include one or more digital and/or analog communication devices that allow computing system 200 to communicate with other machines and devices, such as other components of system 100 shown in FIG. 1. For example, computing system 200 may include interface components that provide interfaces to one or more input devices, such as one or more keyboards, mouse devices, and the like, which may enable computing system 200 to receive input from an operator of device 120.

Computing system 200 may also comprise one or more database(s) 260. Alternatively, computing system 200 may be communicatively connected to one or more database(s) 260. Computing system 200 may be communicatively connected to database(s) 260 through network 130. Database 260 may include one or more memory devices that store information and are accessed and/or managed through computing system 200. By way of example, database(s) 260 may include Oracle™ databases, Sybase™ databases, or other relational databases or non-relational databases, such as Hadoop sequence files, HBase, or Cassandra. The databases or other files may include, for example, data and information related to the source and destination of a network request, the data contained in the request, etc. Systems and methods of disclosed embodiments, however, are not limited to separate databases. Database 260 may include computing components (e.g., database management system, database server, etc.) configured to receive and process requests for data stored in memory devices of database(s) 260 and to provide data from database 260.

As discussed above, user devices 120, devices within payment processing network 160 or network 130, FSP database 150, payment database 170, merchant servers 180, and FSP servers 140 may include at least one computing system 200. Computing system 200 may be a single device or may be configured as a distributed computer system including multiple servers or computers that interoperate to perform one or more of the processes and functionalities associated with the disclosed embodiments.

FIGS. 3-5 are examples of mobile application graphical user interfaces for enabling use of an otherwise disabled payment account in recurring payment transactions, consistent with the disclosed embodiments. In some embodiments, a customer may indicate that a payment account and/or method is authorized for use in a transaction even if the payment account and/or method has otherwise been disabled or declared unusable.

As shown in FIG. 3, a mobile application graphical user interface 300 may be included in a mobile application, such as an Android or iPhone application. For example, a user (see element 311) may log in to the mobile application to view user interface 300. The mobile application may provide graphical user interface elements 338 (“merchants”) and 340 (“charges”). A user may activate element 338 (“merchants”) to view interface 300 that includes a list of merchants with whom payments (see “charges,” element 310) have been transacted using the payment account and/or method. Interface 300 may include information on the user's current preferences with respect to the merchants. For example, interface 300 may provide an identifier of the merchant (such as a merchant name or ID), as shown in elements 314, 318, 322, and 326.

For each merchant, interface 300 may provide an indication of the current status of authorization for payment transactions with the merchant. For example, a status of “paused” (element 315) may indicate that all transactions using the payment account and/or method are currently paused for the merchant. A status of “active” (element 319) may indicate that all transactions using the payment account and/or method are currently active for the merchant. On the other hand, a status of “blocked” (element 323) may indicate that the merchant is not trusted, and all (recurring) payment transactions using the payment account and/or method are permanently disabled or declared unusable for the merchant.

For each merchant, interface 300 may also provide an indication of the current status of authorization for recurring payment transactions with the merchant in the event that a financial service provider identifies fraudulent activity or otherwise declares the payment account and/or method unusable. For example, a status of “discontinued” (elements 316, 320) may indicate that all recurring payment transactions to the merchant using the payment account and/or method are to be discontinued in the event that a financial service provider identifies fraudulent activity or otherwise declares the payment account and/or method unusable. On the other hand, a status of “continuing” (element 324) may indicate that all recurring payment transactions to the merchant using the payment account and/or method are authorized, and are to be continued, even in the event that a financial service provider identifies fraudulent activity or otherwise declares the payment account and/or method unusable.

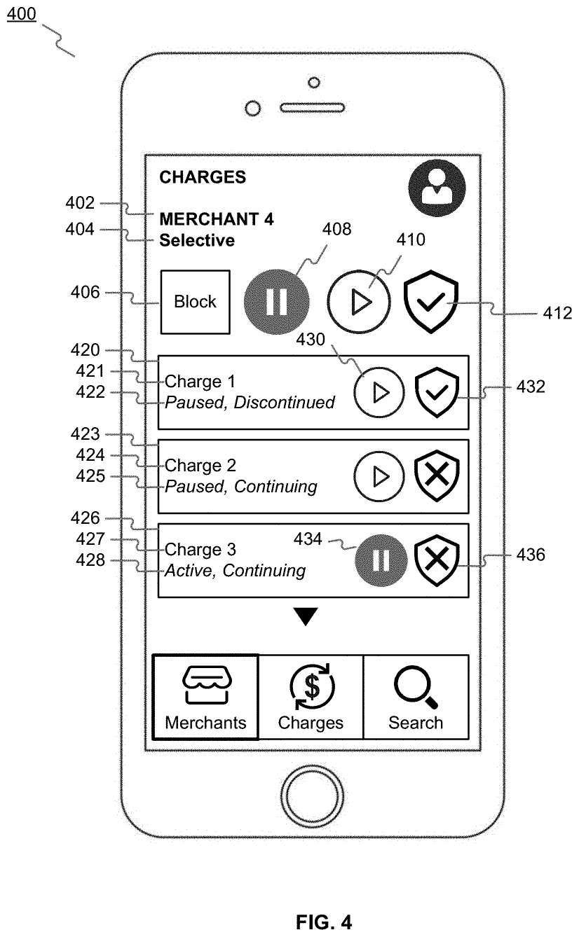

In interface 300, a status of “selective” (element 327) may indicate that the current status of authorization for payment transactions with the merchant and/or the current status of authorization for recurring payment transactions with the merchant in the event of account fraud detection or unusability does not universally apply to all payment transactions and/or recurring payment transactions, but are instead selected individually on a transaction-by-transaction basis for the merchant. A user may activate element 328 to navigate to a mobile application graphical user interface 400 (see FIG. 4) to view and/or modify, on a transaction-by-transaction basis, the current status of authorization for payment transactions with the merchant and/or the current status of authorization for recurring payment transactions with the merchant in the event of account fraud detection or unusability.

As shown in FIG. 4, a mobile application graphical user interface 400 may be included in a mobile application, such as an Android or iPhone application. For example, a user may activate element 328 (FIG. 3) to view interface 400 that includes a list of payments that have been transacted with merchant 402 using the payment account and/or method. Interface 400 may provide an indication 404 of the current status of authorization for payment transactions with the merchant 402 and/or the current status of authorization for recurring payment transactions with the merchant 402 in the event of account fraud detection or unusability. Interface 400 may also include a listing of payments (e.g., 420, 423, 426) transacted with the merchant 402. For each payment transaction, on a transaction-by-transaction basis, interface 400 may include an indication of the current status of authorization of the payment transaction, for example “paused” (elements 422, 425) or “active” (element 428). Interface 400 may also include an indication of the current status of authorization as a recurring payment transaction in the event of account fraud detection or unusability, for example “discontinued” (element 422) or continuing (elements 425, 428).

Returning to FIG. 3, a user of the payment account and/or method, through the mobile app, may provide user input activating an element (e.g., 331) to indicate that a merchant is blocked, so that all (recurring) payment transactions using the payment account and/or method are permanently disabled or declared unusable for the dis-trusted merchant. The user may also provide user input activating an element (e.g., 334) to indicate that a previously unblocked merchant is requested to be unblocked, so that a financial service provider may undertake analysis and/or action to restore active status to (recurring) payment transactions using the payment account and/or method for the merchant.

A user may indicate, on a transaction-by-transaction basis, whether payment transactions with a merchant are temporarily paused or currently active. For example, a user of a payment account and/or method, through the mobile app, may also provide user input to select trusted merchants whose recurring payment requests are authorized even though the user's payment account and/or method has been otherwise deactivated to prevent fraudulent use of the account. For example, a user may activate an element (e.g., 332) to indicate that the user desires to change the current status of authorization for all payment transactions with the merchant to “active.” On the other hand, a user may activate an element (e.g., 336) to indicate that the user desires to change the current status of authorization for all payment transactions with the merchant to “paused.”

The user may further indicate, in the event the user's payment account and/or method has been deactivated to prevent fraudulent use of the account, whether recurring payment transactions with a merchant should be continued or discontinued while the user waits to receive a replacement card and account number. For example, a user may activate an element (e.g., 333) to indicate that the user trusts the merchant, and desires to change the current status of authorization for all recurring payment transactions with the merchant in the event of account fraud detection or unusability to “continuing.” On the other hand, a user may activate an element (e.g., 335) to indicate that the user does not trust the merchant, and desires to change the current status of authorization for all recurring payment transactions with the merchant in the event of account fraud detection or unusability to “discontinued.”

Returning to FIG. 4, in some embodiments, the user may further indicate on a transaction-by-transaction basis, in the event the user's payment account and/or method has been deactivated to prevent fraudulent use of the account, whether recurring payment transactions with a merchant should be continued or discontinued while the user waits to receive a replacement card and account number. For example, a user may activate element 328 (FIG. 3) to view interface 400 that includes a list of payments that have been transacted with merchant 402 using the payment account and/or method. The user may have previously selected preferences for the merchant 404 on a transaction-by-transaction basis (see element 404). The user may be able to set preferences for all payment transactions with the merchant 402 using elements 406, 408, 410, and 412. For example, a user of the payment account and/or method, through the mobile app, may provide user input activating an element (e.g., 406) to indicate that a merchant is blocked, so that all (recurring) payment transactions using the payment account and/or method are permanently disabled or declared unusable for the dis-trusted merchant. Interface 400 may also include an element (not shown) which a user can activate to indicate that a previously blocked merchant is requested to be unblocked, so that a financial service provider may undertake analysis and/or action to restore active status to (recurring) payment transactions using the payment account and/or method for the merchant.

Further, the user may activate an element (e.g., 408) to indicate that the user desires to change the current status of authorization for all payment transactions with the merchant to “active.” On the other hand, the user may activate an element (e.g., 410) to indicate that the user desires to change the current status of authorization for all payment transactions with the merchant to “paused.” Also, the user may activate an element (e.g., 412) to indicate that the user trusts the merchant, and desires to change the current status of authorization for all recurring payment transactions with the merchant in the event of account fraud detection or unusability to “continuing.” Interface 400 may also include an element (not shown) which a user can activate to indicate that the user does not trust the merchant, and desires to change the current status of authorization for all recurring payment transactions with the merchant in the event of account fraud detection or unusability to “discontinued.”

The user may further provide such input on a transaction-by-transaction basis. For example, the user may activate an element (e.g., 430) to indicate that the user desires to change the current status of authorization for a specific payment transaction with the merchant to “active,” or activate another element (e.g., 434) to indicate that the user desires to change the current status of authorization for a specific payment transaction with the merchant to “paused.” Similarly, the user may activate an element (e.g., 432) to indicate that that the user trusts the merchant, and desires to change the current status of authorization for a specific recurring payment transaction with the merchant in the event of account fraud detection or unusability to “continuing.” Also, the user may activate an element (e.g., 436) to indicate that the user does not trust the merchant, and desires to change the current status of authorization for a specific recurring payment transaction with the merchant in the event of account fraud detection or unusability to “discontinued.”

Returning to FIG. 3, interface 300 may provide the user with a user interface element (e.g., 360), which the user can use to search for a specific payment transaction, and then input preferences for that payment transaction.

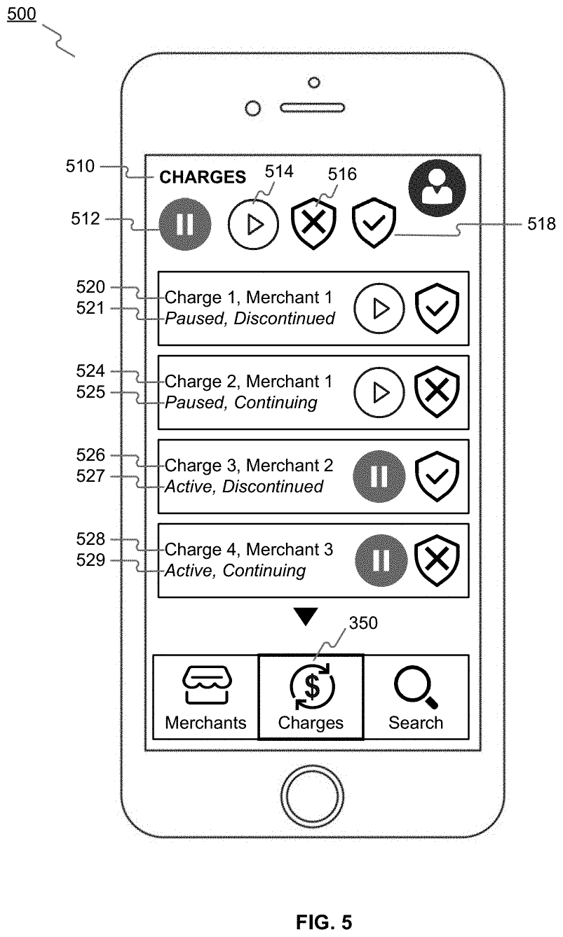

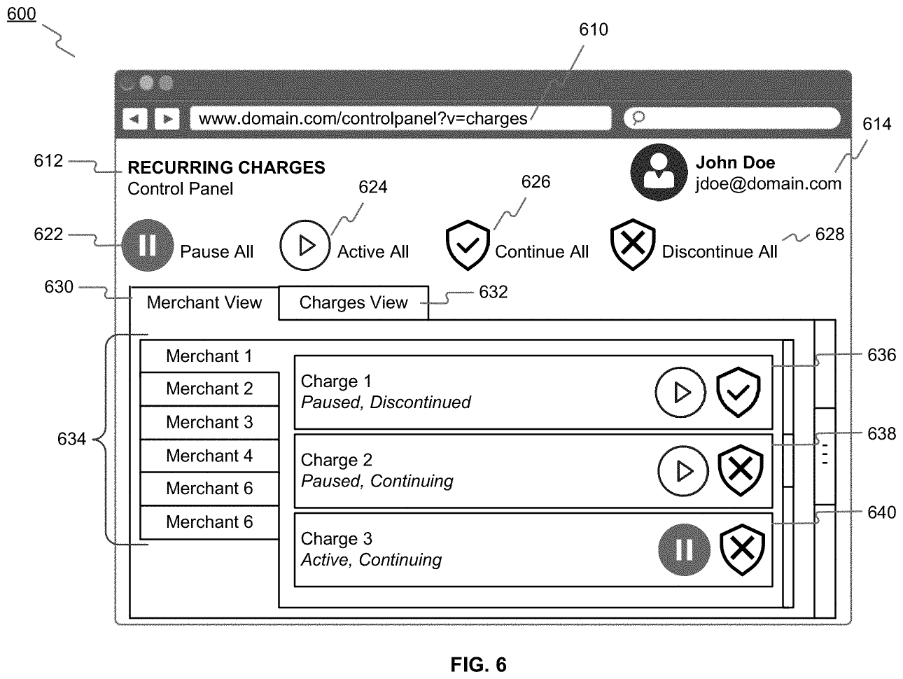

Also, interface 300 may include an element (e.g., 350) to change the user interface so that all transactions are listed, e.g., in order of date or amount of transaction, rather than grouped by merchant (see, e.g., 340). As shown in FIG. 5, an interface 500 may include a list of payment transactions (see “charges,” element 510) have been transacted using the payment account and/or method. Interface 500 may include information on the user's current preferences with respect to the payment transactions. For example, interface 500 may include an identifier of the payment transaction and an identifier of the merchant (such as a merchant name or ID) associated with the payment transactions (see e.g., 520, 524, 526, and 528). Interface 500 may further include information on the current status of authorization of the payment transactions, for example “paused” (elements 521, 525) or “active” (elements 527, 529). Interface 500 may also include information on the current status of authorization as a recurring payment transaction in the event of account fraud detection or unusability, for example “discontinued” (elements 521, 527) or “continuing” (elements 525, 529). Interface 500 may also provide user interface elements to pause (512), activate (514), discontinue (516) or continue (518) all listed payment transactions.

The user's preferences may be stored by a financial service provider or other payment processing entity.

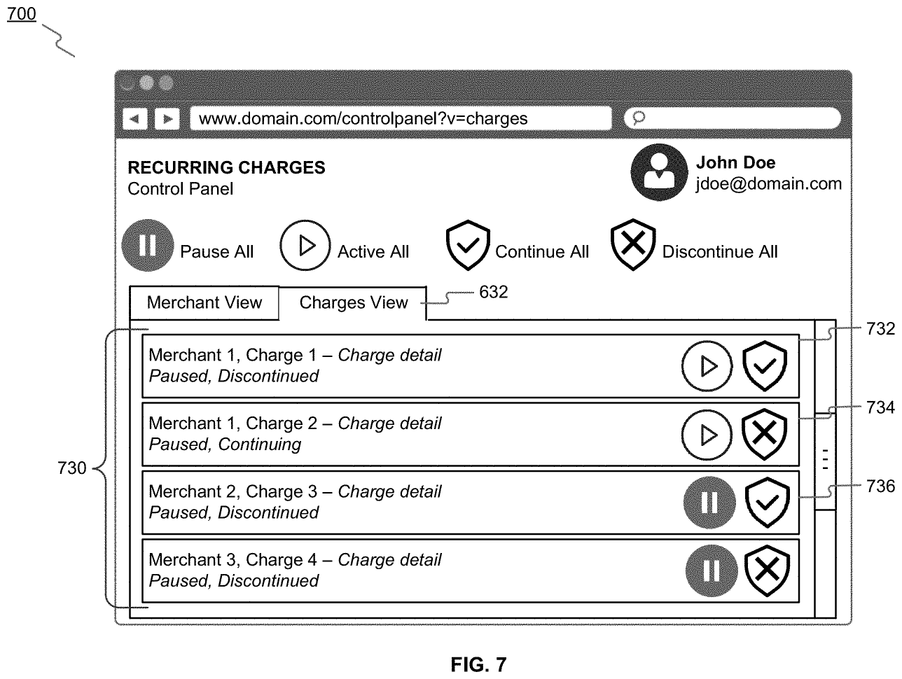

FIGS. 6-7 are examples of web browser graphical user interfaces for enabling use of an otherwise disabled payment account in recurring payment transactions, consistent with the disclosed embodiments. A user of a payment account and/or method, through a web browser interface, may identify trusted merchants whose recurring payment requests are authorized even though the user's payment account and/or method has been otherwise deactivated to prevent fraudulent use of the account.

For example, as shown in FIG. 6, a user may navigate to a URL 610 using a web browser, and login to an online account (see element 614) to load web browser graphical user interface 600 into the web browser. Interface 600 may provide various views of recurring payment transactions 612. For example, interface 600 may allow a user to view the recurring payment transactions grouped by merchant (by activating element 630), or view all of the recurring payment transactions sorted by date, amount, or other parameters (by activating element 632). Interface 600 may allow a user to set preferences for all payment transactions using elements 622 (pause all), 624 (activate all), 626 (continue all), and 628 (discontinue all).

In the merchant view 630, interface 600 may provide a list of merchant 634, and details of payment transactions (e.g., 636, 638, 640) grouped by merchant. As discussed above with reference to FIGS. 3-4, a user may view, set, and/or edit information on the current status of authorization of the payment transactions (e.g., paused or active), and on the current status of authorization as a recurring payment transaction in the event of account fraud detection or unusability (e.g., discontinued or continuing).

As shown in FIG. 7, web browser interface 700 may allow a user, by activating element 632, to view a list 730 of the recurring payment transactions sorted by date, amount, or other parameters. Interface 700 may provide information on each of the listed payment transactions and provide user interface elements for a user to modify the user's authorization settings (see 732, 734, and 736), in a similar manner as described above with respect to FIGS. 3-5.

The user's preferences may be stored by a financial service provider or other payment processing entity.

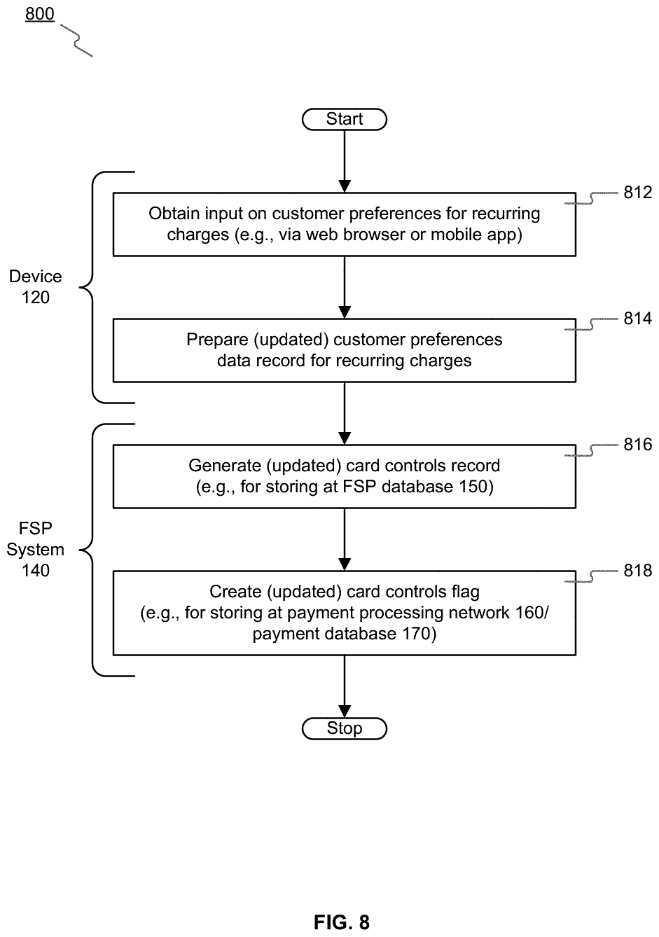

FIG. 8 is a flowchart of an exemplary process for enabling use of an otherwise disabled payment account in recurring payment transactions, consistent with the disclosed embodiments. In some embodiments, a payment account and/or method may be declared unusable based on a detection of actual or probable fraud, or as a preventive measure based on an increased risk of fraud, such as may result from a data breach, for example, or for any other reason in which it may be advantageous to restrict or prohibit use of a payment account and/or method. Fraudulent activity using a payment account and/or method may be determined by a FSP system 140, one or more systems of payment processing network 160, or by user 110. Fraudulent activity may be determined according to any known manner using a variety of techniques and analysis to detect or determine potential fraud. Upon detection of actual or possible fraudulent activity using known systems and techniques or as a preventive measure etc., FSP system 140 associated with the payment account and/or method may declare the payment account and/or method unusable. The payment account and/or method may remain unusable, for example, until a replacement payment method is issued and received.

In some embodiments, a user 110 may be notified that the user's payment account and/or method may be or has been declared unusable. The user 110 may receive indication via any known methods including via an e-mail, text message, phone call, or other indication received via user device 120. For example, indication may be received by an in-app message or indication provided by an application executed on user device 120, such as an app associated with a financial service provider with which the payment method or account is held. The app may be a proprietary app enabling user 110 to manage his account with the financial service provider, as well as to provide other functionality disclosed herein. Additionally, in some embodiments, user 110 may be notified that the user's payment account and/or method is unusable based on an attempted transaction that was not authorized. Any other manner or method of receiving indication that a payment account and/or method has been declared unusable is contemplated by the present disclosure.

In some embodiments, upon declaring a payment account and/or method as unusable, FSP system 140 may provide an app (or app update) providing functionality particular to the disclosed methods to user 110 for executing on user device 120. The app or app update may thus enable a user to provide authorization to continue use of the payment account and/or method according to the disclosed embodiments. For example the app or app update may provide to user 110 graphical user interfaces such as those described above with respect to FIGS. 3-7. Additionally, in some embodiments, certain functionality particular to the disclosed methods may be “unlocked” within an existing financial service provider app executed on user device 120. Other methods for enabling user device 120 to perform the disclosed methods are contemplated by the present disclosure.

As shown in FIG. 8, a customer may indicate that a payment account and/or method is authorized for use in a transaction even if the payment account and/or method has otherwise been disabled or declared unusable. In step 812, device 120 may obtain input on customer preferences for recurring charges. For example, a customer may use a graphical user interface such as those described above with reference to FIGS. 3-7 to indicate whether recurring payment transactions with a merchant are authorized in the event that a financial service provider identifies fraudulent activity or otherwise declares the payment account and/or method unusable.

In step 814, device 120 may prepare a customer preferences data record that includes the customer preferences. In some embodiments, where the customer has updated previously entered preferences, device 120 may prepare an update customer preferences data record. For example, device 120 may encode the customer's input into the user interface, along with a user ID for the customer, in an XML data format as the (updated) customer preferences data record, and send the (updated) customer preferences data record via a HTTP(S) POST message to FSP system 140.

A customer preferences data record may be transmitted to FSP system 130 using an app executed on user device 120. The app executed on user device 112 may include software and/or hardware instructions to generate an interface displayed on user device 112, similar to that described below in FIGS. 3-7. An exemplary interface may be configured to enable user 110 to quickly authorize anticipated recurring transactions using the exemplary graphical user interfaces described above. The exemplary interface may also enable user 110 to provide additional parameters related to the authorized recurring transactions.

In some embodiments, user 110 may be instructed to input various information related to the authorized recurring transaction, such as a merchant identifier, anticipated transaction amount, etc. For an e-commerce type of transaction, user 110 may also be instructed to input additional information regarding the website or other identifier of the e-commerce merchant, in addition to a device identifier used to initiate the remote e-commerce transaction. Other information that may be useful for authenticating a transaction, such as an IP address of the device initiating a transaction, may also be requested by the app from the user. The additional information may be provided by user 110 using an input on user device 120, for example. In other embodiments, some of the information (such as a device identifier or IP address) may automatically be generated and transmitted by user device 120.

In step 816, FSP system 140 may generate an updated card controls record. For example, FSP system 140 may receive the (updated) customer preferences data record from device 120, and extract a user ID from the (updated) customer preferences data record. Using the user ID, FSP system 140 may query a FSP database 150 for the user's card controls record. If a card controls record does not exist for the user, FSP system 140 may generate a new card controls record. FSP system 150 may compare any existing card controls record with the (updated) customer preferences data record received from device 120, and may modify the card controls record associated with the user ID based on the user input encoded in the (updated) customer preferences data record. FSP system 140 may store the card controls record in FSP database 150.

In some embodiments, the (updated) card controls record may store the user's authorization preferences in the form of transactions rules. For example, one or more transaction rules may be associated with a payment account and/or method, the transaction rule being based at least in part on the information received from the user, for example via the graphical user interfaces of FIGS. 3-7. In some embodiments, the transaction rule may include information included in a payment request received from a merchant system 180. The particular payment account with which to associate the transaction rule may be determined based on a user or account identifier received from the user, or included in the merchant system's payment request. The identified payment account and/or method, or a list or database containing an identifier of the payment account and/or method, may then be updated, similar to the method described above with respect to step 405, to associate the transaction rule with the payment account. For example, in some embodiments, a status indicator corresponding to a payment account and/or method may be updated or changed to reflect that the payment account and/or method is associated with a transaction rule. Additionally, in some embodiments a data record associated with the payment account and/or method may be updated to include the transaction rule or an indication of one or more transaction rules. In other embodiments, a separate list or database may be generated to include identifiers of payment accounts and/or methods associated with a transaction rule. Any number of other methods for associating a payment account and/or method with a transaction rule and identifying the payment account and/or method as being associated with a transaction rule are contemplated by the present disclosure.

In step 818, FSP system 140 may generate or update a card controls flag for the payment processing network 150. For example, if, based on the updated card controls record for the user ID, FSP system 140 determines that the user has authorized at least one active and continuing recurring payment transaction, then FSP system 140 may set the card controls flag value to “enabled” (e.g., bit 1). If, on the other hand, FSP system 140 determines that the user has not authorized any recurring payment transaction as active and continuing, then FSP system 140 may set the card controls flag value to “disabled” (e.g., bit zero). FSP system 140 may send the user ID and (updated) card controls flag, for example encoded as XML data in a HTTP(S) POST message, to payment processing network 160. Payment processing network 160 may store the user ID and (updated) card controls flag in payment database 170.

The exemplary embodiments are not limited to the above examples for updating a data record. Numerous other methods may be implemented to indicate a status of a payment account and/or method or change a status of a payment account and/or method, consistent with the disclosed embodiments. Additionally, in some embodiments, the updated status or indication may correspond to one or more “states” of a payment account and/or method. Thus, for example, a first indication may signify that a payment account and/or method is unusable, whereas a second indication may signify that the payment account and/or method is unusable unless one or more conditions or transaction rules are met. Numerous other “states” may be implemented to correspond to one or more other conditions or restrictions on a payment account and/or method.

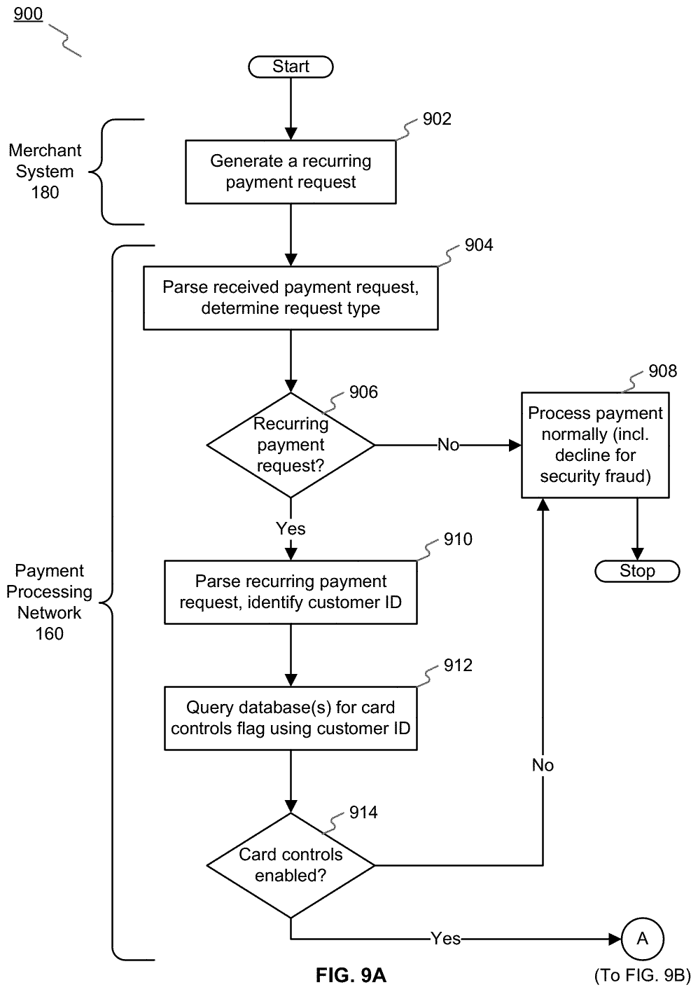

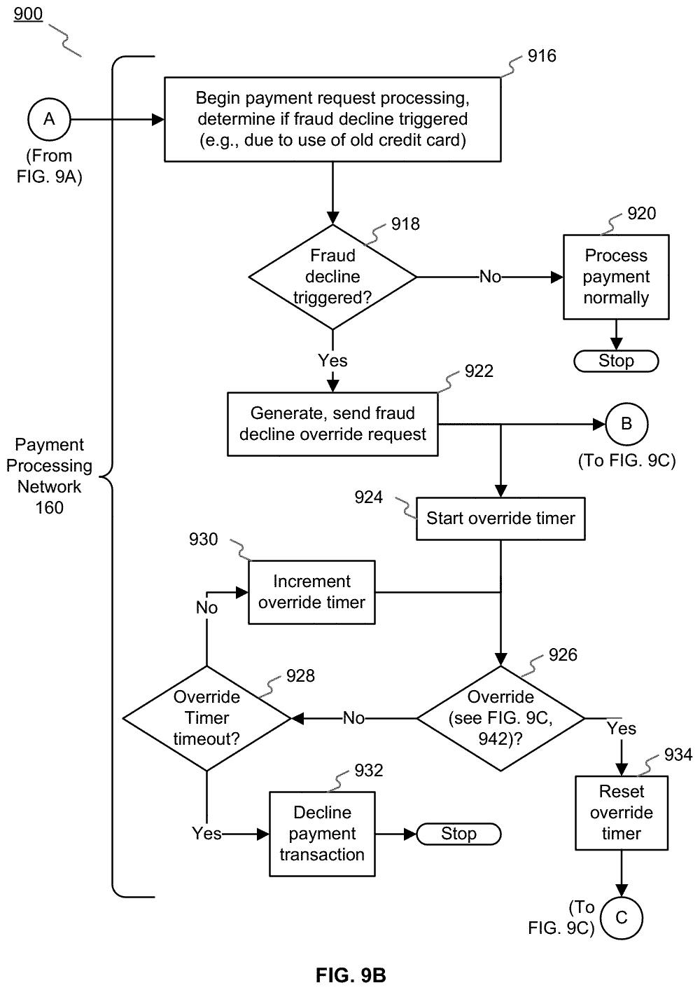

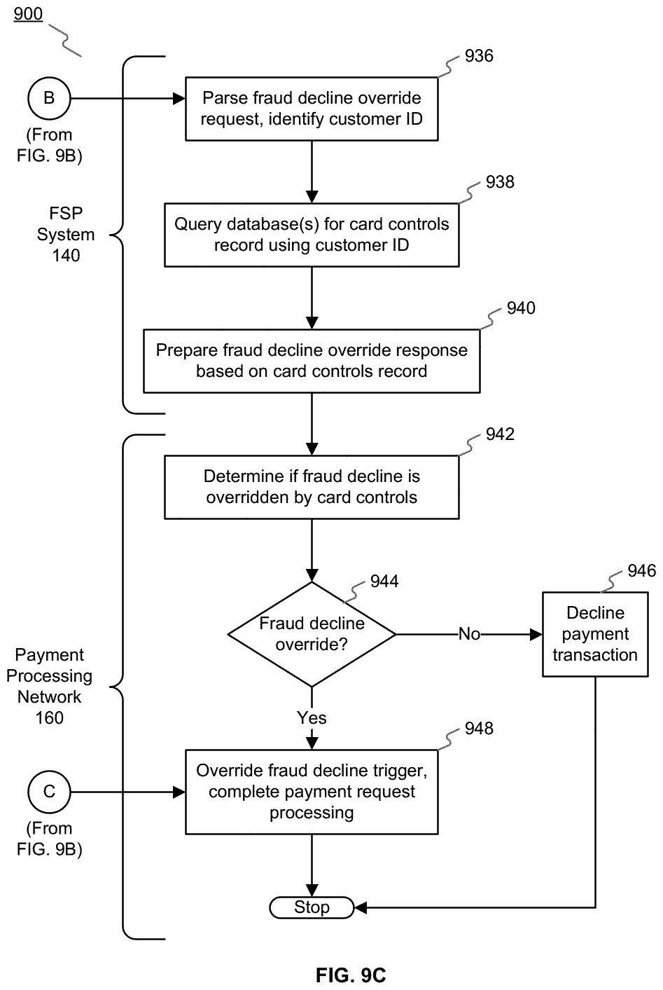

FIGS. 9A-C are flowcharts of an exemplary process for processing a recurring payment transaction using an otherwise disabled payment account, consistent with the disclosed embodiments.

As shown in FIG. 9A, in step 902, a merchant system 180 may generate a request for a recurring payment transaction, and send the request to payment processing network 160. The transaction may be initiated using a payment account and/or method that was previously declared unusable. The transaction may be initiated at a physical merchant location associated with merchant system 180, for example, or may be initiated remotely, such as for an e-commerce transaction. Upon initiating a transaction, a merchant system 180 may request authorization of the transaction using known payment authorization systems improved by the disclosed embodiments.

In step 904, payment processing network 160 may receive the request from the merchant system 180. In some embodiments, the transaction data received may include information related to the nature of the transaction, a timestamp of the transaction, an amount of the transaction, a user or account identifier, merchant identifier, and merchant location information, as well as any other related information. In some embodiments, the received request may include information indicating that the anticipated transaction is an e-commerce type of transaction, as well as information identifying the e-commerce web-site and information identifying a device to be used for the transaction. E-commerce type transactions may be more susceptible to fraudulent behavior, thus in some embodiments, more specific information regarding an anticipated transaction may be received. In some embodiments, such as where a transaction is initiated remotely from a physical location of a merchant via a web-site or other e-commerce type of transaction, an IP address of the computing device used to initiate the transaction may be included as part of transaction data.

Payment processing network 160 may include a number of systems associated with processing, clearing, and settling a transaction. The transaction data received in step 904 may be analyzed by one or more systems provided as part of payment processing network 160 to determine the payment method or account used to initiate the transaction. One or more of the systems associated with payment processing network 160 may perform certain pre-authorization and authentication checks on the payment account and/or method before presenting the transaction authorization request to the user's financial service provider associated with the payment account and/or method.

Payment processing network may extract the request data from the request, and determine whether it is a recurring payment request. For example, payment processing network may compare the request details to previous transactions that payment processing network 160 has processed for the merchant system 180, and determine whether the requested transaction is the same as a previously requested transaction. In some embodiments, payment processing network may determine a frequency and period of time of the recurring requests, and may determine whether the request is a recurring payment request if a frequency can be determined, and/or if the period of time of the recurring requests exceeds a threshold value.

In step 906, if payment processing network 160 determines that the requested transaction is not a recurring payment request, in step 908, payment processing network 160 may process the payment request as a normal transaction. This may include declining a payment transaction in the event that a financial service provider previously identified fraudulent activity or otherwise declared the payment account and/or method associated with the payment request unusable.

In step 906, if payment processing network 160 determines that the requested transaction is a recurring payment request, in step 910, payment processing network 160 may parse the recurring payment request and extract or otherwise determine a user ID for the customer, for example by querying payment database 170 using a payment account number provided in the payment request for the user ID. In step 912, payment processing network 160 may query payment database 170 using the user ID for a card control flag (see, e.g., FIG. 8, step 818).

In step 914, if payment processing network 160 determines that card controls are not enabled for the customer associated with the user ID, payment processing network 160 may process the payment request as a normal transaction (see, e.g. step 908). This may include declining a payment transaction in the event that a financial service provider identifies fraudulent activity or otherwise declares the payment account and/or method associated with the payment request unusable. On the other hand, if payment processing network 160 determines that card controls are enabled for the customer associated with the user ID, payment processing network 160 may continue processing as shown in FIG. 9B.

As shown in FIG. 9B, in step 916, payment processing network 160 may begin processing payment in the ordinary fashion, including determining whether the payment request should be declined because of identified fraudulent activity or the payment account and/or method associated with the payment request is declared unusable. In step 918, if payment processing network 160 determines that such a fraud decline is not triggered, in step 920, payment processing network 160 may continue processing the payment normally.

On the other hand, payment processing network 160 may determine that such a fraud decline is triggered. If so, in step 922, because card controls have been enabled for the user ID associated with the payment account and/or method included in the payment request, payment processing network 160 may generate and send a fraud decline override request including the user ID and information on the payment request from the merchant system 180 to FSP system 140. In some embodiments, payment processing network 160 may maintain an override timer to implement an additional layer of security. For example, if payment processing network 160 does not receive a response to its fraud decline override request from FSP system 140 within a predetermined time from the issuance of the request, payment processing network 160 may determine that the transaction is not secure and decline the transaction for potential fraudulent activity. For example, in step 924, payment processing network 160 may initiate an override timer. In step 926, payment processing network 160 may continually determine whether the override request has been granted by FSP system 140. If the FSP system 140 grants the override request before the override timer times out, in step 934, payment processing network 160 may reset the override time, and proceed with processing the payment request (see FIG. 9C, step 948). On the other hand, if payment processing network 160 determines that the override request has not yet been granted by FSP system 140, in step 928, payment processing network 160 may determine whether the override time has timed out. If the override timer has timed out, in step 932, payment processing network 160 may determine that the transaction is not secure and decline the transaction for potential fraudulent activity. If the override time has not timed out yet, in step 930, payment processing network 160 may increment the override timer and continue waiting for an override response from FSP system 140.

As shown in FIG. 9C, FSP system 140 may receive a fraud decline override request from payment processing network 160. In step 936, FSP system may parse the fraud decline override request and extract the user ID and the information on the payment request from the merchant system 180. In step 938, using the user ID, FSP system 140 may query FSP database 150 for a card controls record associated with the user ID (see FIG. 8, step 816). In step 940, FSP system 140 may compare the information on the payment request from the merchant system 180 with the card controls record. If the FSP system 140 determines that the card controls record contains information or transaction rules corresponding to the payment request from the merchant system 180, FSP system 140 may identify the corresponding card controls information or transaction rules in the card controls record. In some embodiments, FSP system 140 may query FSP database 150, using the information on the payment request from the merchant system 180, for the relevant card control information or transaction rules. The card control information and/or transaction rules may include whether the payment request from the merchant system 180 is one that the user previously authorized as active and continuing in the event of account fraud detection or unusability. Based on the corresponding card control information, FSP system 140 may generate and send to payment processing network 160 a fraud decline override response, for example, indicating that the fraud decline override request is either granted or denied.

In step 942, payment processing network 160 may receive the fraud decline override response from FSP system 140, and determine if the fraud decline override request is granted or denied. If the fraud decline is not overridden, payment processing network 160 may determine that the transaction is not secure and decline the transaction for potential fraudulent activity. On the other hand, if the fraud decline is overridden, in step 948, payment processing network 160 may proceed with and complete processing the payment request despite the fraud decline being triggered in FIG. 9B, step 918.

The disclosed embodiments enable a user 110 to continue use of a payment method or account that has been declared unusable by providing an additional layer of security or authorization on top of the measures implemented under standard use of the payment method or account. For example, some embodiments enable continued use, on a restricted basis, of a payment account and/or method for which a financial service provider has identified fraudulent activity or has otherwise declared unusable. In some embodiments, continued use of the payment account and/or method may be limited to certain user-authorized recurring transactions with trusted merchants. A user of the payment account and/or method, through a mobile app or web browser interface, may identify trusted merchants whose recurring payment requests are authorized even though the user's payment account and/or method has been otherwise deactivated to prevent fraudulent use of the account. Such restricted and/or limited use of the payment account and/or method for specific recurring payment transactions present a lower probability of fraudulent behavior, and have been authorized by the user who has also indicated that the requesting merchant is trusted. Since the authentication measures are dynamic, they are not easily spoofed or otherwise capable of re-creation by a fraudster. Additionally, in some embodiments, a payment account and/or method may be “activated” for a specific recurring transaction or set of recurring transactions for a limited duration of time in which a trusted merchant may initiate the recurring transaction using the payment account and/or method. It is unlikely that a fraudster may coincidentally also attempt to use the payment account for a transaction during the limited window of time. Thus, even if the payment method or account has been compromised, it may be unlikely that a fraudulent transaction will coincidentally be initiated during the limited duration of time associated with the temporary transaction authorization request.

The above-described processes may be implemented as a computer program or application or as a plugin module or sub component of another application. Some of the described processes may be executed by a computing system 200 of merchant system 180, payment processing network 160, FSP system 140, user device 120 or other system provided as part of payment processing network 160 or network 130. The described techniques may be varied and are not limited to the examples or descriptions provided.

While illustrative embodiments have been described herein, the scope thereof includes any and all embodiments having equivalent elements, modifications, omissions, combinations (e.g., of aspects across various embodiments), adaptations, and/or alterations as would be appreciated by those in the art based on the present disclosure. For example, the number and orientation of components shown in the exemplary systems may be modified. Further, with respect to the exemplary methods illustrated in the attached drawings, the order and sequence of steps may be modified, and steps may be added or deleted.

Thus, the foregoing description has been presented for purposes of illustration. It is not exhaustive and is not limiting to the precise forms or embodiments disclosed. Modifications and adaptations will be apparent to those skilled in the art from consideration of the specification and practice of the disclosed embodiments. For example, while a financial service provider has been described herein as the entity performing the transaction authorization methods, it is to be understood that consistent with disclosed embodiments another entity provided as part of payment processing network 160, for example, may provide such services in conjunction with or separate from a financial service provider. In some embodiments, a financial service provider may provide the disclosed account information and user recurring payment preferences as part of a database (e.g., 150, 170) accessible to payment processing network 160.

The claims are to be interpreted broadly based on the language employed in the claims and not limited to examples described in the present specification, which are non-exclusive. For example, aspects of the disclosed embodiments are described as being associated with data stored in memory, and one skilled in the art will appreciate that these aspects can be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

1-20. (canceled)

21. A computer-implemented method, comprising:
providing data for displaying a graphical user interface, wherein the graphical user interface comprises:
a merchant display area for displaying merchant information associated with a payment account, wherein the merchant transaction information comprises:
a merchant identifier associated with a merchant; and
a merchant authorization indication, wherein the merchant authorization indication indicates a current status of authorization for payment transactions associated with the merchant; and
a merchant authorization area configured to receive an input related to authorization for payment transactions with the merchant;
receiving an input at the merchant authorization area; and
changing the merchant authorization indication based on the received input.

22. The method of claim 21, wherein the merchant authorization indication indicates that all or no transactions associated with the merchant are currently authorized.

23. The method of claim 21, wherein the merchant authorization indication indicates that some transactions associated with the merchant are currently authorized.

24. The method of claim 21, wherein the merchant authorization indication indicates that all or no recurring transactions associated with the merchant are currently authorized.

25. The method of claim 21, wherein the merchant authorization indication indicates that some recurring transactions associated with the merchant are currently authorized.

26. The method of claim 21, wherein the merchant authorization indication indicates an account fraud detection or unusability.

27. The method of claim 21, wherein the graphical user interface further comprises an interface change area configured to receive an input to search for information associated with a specific transaction.

28. The method of claim 21, wherein:
the graphical user interface is a first graphical user interface, the first graphical user interface further comprising an interface change area configured to receive an input to display a second graphical user interface; and
the method further comprises displaying a second graphical user interface if the interface change area receives an input to display the second graphical user interface.

29. The method of claim 28, wherein the second graphical user interface comprises:
a transaction display area for displaying transaction information, wherein the transaction information comprises:
a charge identifier associated with a transaction associated with the payment account; and
a transaction authorization indication, wherein the transaction authorization indication indicates a current status of authorization for payment of the transaction.

30. The method of claim 29, wherein:
the second graphical user interface further comprises:
a transaction authorization area configured to receive an input related to the transaction and authorization for payment of the transaction; and
the method further comprises:
receiving an input at the transaction authorization area, and
changing the transaction authorization indication based on the received input.

31. A system, comprising:
at least one processor; and
at least one memory device storing instructions executable by the processor to perform operations comprising:
displaying a graphical user interface, wherein the graphical user interface comprises:
a merchant display area for displaying merchant information associated with a payment account, wherein the merchant transaction information comprises:
a merchant identifier associated with a merchant; and
a merchant authorization indication, wherein the merchant authorization indication indicates a current status of authorization for payment transactions associated with the merchant; and
a merchant authorization area configured to receive an input related to authorization for payment transactions with the merchant; and
receiving an input at the merchant authorization area; and
changing the merchant authorization indication based on the received input.

32. The system of claim 31, wherein the graphical user interface further comprises an interface change area configured to receive an input to search for information associated with a specific transaction.

33. The system of claim 31, wherein:
the graphical user interface is a first graphical user interface, the first graphical user interface comprising an interface change area configured to receive an input to display a second graphical user interface; and
the operations further comprise displaying a second graphical user interface if the interface change area receives an input to display the second graphical user interface.

34. The system of claim 33, wherein the second graphical user interface comprises:
a transaction display area for displaying transaction information, wherein the transaction information comprises:
a charge identifier associated with a transaction associated with the payment account; and
a transaction authorization indication, wherein the transaction authorization indication indicates a current status of authorization for payment of the transaction.

35. The system of claim 34, wherein:
the second graphical user interface further comprises:
a transaction authorization area configured to receive an input related to the transaction and authorization for payment of the transaction; and
the operations further comprise:
receiving an input at the transaction authorization area; and
changing the transaction authorization indication based on the received input.

36. A non-transitory computer-readable medium storing instructions executable by at least one processor to perform operations comprising:
displaying a graphical user interface, wherein the graphical user interface comprises:
a transaction display area for displaying transaction information, wherein the transaction information comprises:
a charge identifier associated with a transaction associated with the payment account;
a transaction authorization indication, wherein the transaction authorization indication indicates a current status of authorization for payment of the transaction; and
a transaction authorization area;
receiving an input at the transaction authorization area; and
changing the transaction authorization indication based on the received input.

37. The medium of claim 36, wherein:
the graphical user interface is a first graphical user interface, the first graphical user interface comprising an interface change area configured to receive an input to display a second graphical user interface; and
the operations further comprise displaying a second graphical user interface if the interface change area receives an input to display the second graphical user interface.

38. The medium of claim 37, wherein:
the interface change area is a first interface change area; and
the first graphical user interface further comprises a second interface change area configured to receive an input to search for information associated with a specific transaction.

39. The medium of claim 38, wherein the second graphical user interface comprises a third interface change area configured to receive an input to display the first graphical user interface.

40. The medium of claim 39, the operations further comprising displaying the first graphical user interface if the third interface change area receives an input to display the first graphical user interface.
